(19) United States
(12) Patent Application Publication
(10) Pub. No.: US 2018/0183382 A1
(43) Pub. Date: Jun. 28, 2018

(54) Interlocking Roofing System

(71) Applicants: David R. Hall, Provo, UT (US); Seth Myer, Eagle Mt., UT (US)

(72) Inventors: David R. Hall, Provo, UT (US); Seth Myer, Eagle Mt., UT (US)

(21) Appl. No.: 15/391,347

(22) Filed: Dec. 27, 2016

(51) Int. Cl. H02S 20/25; E04D 1/26; E04D 1/36

(52) U.S. Cl. CPC H02S 20/25; E04D 1/36; E04D 1/26

(57) ABSTRACT

An interlocking roofing system is disclosed which simplifies the installation of roofing shingles, creates a stronger seal between the side edges of adjacent shingles, and further strengthens the attachment of the system to the roof and between the rows of shingles.

The interlocking roofing system comprises shingles that are adhesively connected together and adhesively attached to the roof deck, the connection between the shingles forming a channel which draws water away from the adhesive connection area.

The interlocking roofing system further comprises solar shingles that are adhesively and electrically interconnected, extending the circuiting via an electrical interconnection system to an electrical system or electrical devices.

### BACKGROUND

### Field of the Invention

This invention relates to interlocking roofing systems for connecting a series of shingles together and attaching them to a roof.

### Background of the Invention

Typically, many roofing systems comprise a series of shingles installed onto a roof deck which has been covered by tar paper or other underlayment material. The shingles are attached to the roof deck with staples or nails. The overlapping tabs of each shingle are held to the shingle they are laying on top of by a strip of tar.

This traditional roofing system works well under normal conditions. However, when it is windy the tabs can be lifted up by the force of the wind, forcing the shingles up and in some cases lifting several rows of shingles and blowing them off of the roof

Another weak area in traditional roofing systems is the transition between two shingles at the side edges of the shingles where they butt together. Wind and water intrusion at this seam can reduce the life of the shingles and roofing system and can potentially expose this transition area to the elements if not properly sealed.

A system is needed that interlocks both sides of each shingle with adjacent shingles, and further has a stronger attachment at the tabs where they rest on top of a row of shingles.

Currently, roof systems are not known that integrate solar photovoltaic modules into the roofing material that match the look and style of the rest of the shingles on the roof. It is desirable that the roofing system incorporates solar shingles that are compatible with and able to interface with the non-solar shingles on the roof.

In summary, the key advantages posited for the interlocking roofing system include a system that:

provides interlocking side edges between a series of shingles sealing the connection and preventing water or the elements from degrading this connection area.

adhesively attaches shingles to the roofing deck and to a row of shingles they are laying on top of, preventing wind from lifting up the shingles.

provides solar shingles with photovoltaic modules integrated within, wherein these solar shingles match the color and style of standard non-solar shingles on the roof.

### SUMMARY

This invention has been developed in response to the present state of the art and, in particular, in response to the problems and needs in the art that have not yet been fully solved by currently available systems and methods. Features and advantages of different embodiments of the invention will become more fully apparent from the following description and appended claims, or may be learned by practice of the invention as set forth hereinafter.

Consistent with the foregoing, an interlocking roofing system is disclosed which simplifies the installation of roofing shingles, creates a stronger seal between the side edges of adjacent shingles, and further strengthens the attachment of the system to the roof and between the rows of shingles.

In one embodiment, the interlocking roofing system includes one or more shingles, each shingle with opposed side edges including a protruding edge on one side and a receiving edge on the other side, where the protruding edge of a first shingle overlaps the receiving edge of a second shingle creating an overlap area between a bottom surface of the first shingle and a top surface of the second shingle. The first shingle interlocks with the receiving edge of the second shingle creating a channel opening at a transition between the first shingle and the second shingle. The channel opening runs extends from a top edge of a row of connected shingles to a bottom edge of the row of connected shingles.

In another embodiment, each shingle further includes one or more channels on a top face of each shingle running parallel to the channel opening at the transition from a location at least 1″ from a top edge of a row of connected shingles and extending to a bottom edge of the row of connected shingles, the base of the channel ramping down to the bottom edge of the row of connected shingles.

In an embodiment, the first shingle has a convex channel shape within the overlap area that conforms to the second shingle which has a concave channel shape within the overlap area.

In another embodiment, a roof facing side of each shingle further includes an adhesive covered by a protective backing material; wherein the protective backing material is removed at a time of installation, exposing the adhesive.

In an embodiment, a solar shingle of the one or more shingles includes a photovoltaic current producing module embedded within the solar shingle.

In another embodiment, a combined shingle includes a photovoltaic current producing module section embedded within a portion of the combined shingle. The remaining part of the shingle is made of standard roofing materials.

In one embodiment, a congruent shingle is made of standard roofing material composition that is congruent visually with the solar shingle and the combined shingle having similar or matching color and texture.

In another embodiment, the solar shingle comprises amorphous photovoltaic material.

In an embodiment, the solar shingle further includes a plurality of contacts wherein the contacts electrically connect the solar shingle to an adjacent solar shingle or combined shingle; the solar shingle further including electrical wiring connecting the photovoltaic current producing module to the contacts.

In another embodiment, the photovoltaic current producing module further includes control circuiting which controls an electrical current flowing between one or more solar shingles.

In one embodiment, one or more solar shingles are connected to an electrical interconnection system which includes: one or more linear lengths of partially insulated electrical conductors, a waterproof membrane; wherein the partially insulated electrical conductors are embedded within the membrane, a conductive surface of the partially insulated electrical conductors being exposed on an exterior surface of the membrane, electrical wires connected to each of the one or more linear lengths of partially insulated electrical conductors and extending outside of the membrane to an electrical circuit, and wherein the conductive surface on the exterior surface of the membrane is only exposed in areas that align to contacts of the one or more solar shingles electrically connected thereto.

In another embodiment, the conductive surface is adhesively attached and electrically connected to one or more solar shingles.

In an embodiment, one or more solar shingles further include electrical contacts that provide the electrically connected pathway from the one or more solar shingles to the conductive surface.

In one embodiment, the conductive surface is coated with electrical connection materials enabling electrical conduction from the electrical contacts to the conductive surface.

In another embodiment, an electrically insulating adhesive coats a surface area between a first side of the membrane and the one or more solar shingles, creating an air tight and moisture tight seal encapsulating an area surrounding the electrical connection materials.

In one embodiment, the electrical conductors and conductive surface includes one or more of electrically conductive materials including alloys of copper, aluminum, nickel, stainless steel, silver, graphite, tungsten, and carbide.

In an embodiment, the electrical connection materials comprise electrically conductive adhesive.

In another embodiment, the electrically conductive adhesive comprises one or more electrically conductive materials of carbon, graphite, tungsten, graphene, gallium, rubidium, phosphorus, carbon nanotubes and carbide.

In an embodiment, the electrically insulating adhesive allows for expansion and contraction.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is an isometric view of a solar shingle, according to one example embodiment.

FIG. 2A is an isometric view of a two adjacent shingles not connected together, according to one embodiment.

FIG. 2B is an isometric view of a two adjacent shingles 110 connected together, according to one embodiment.

FIG. 3 is a cross section view showing the connection of two adjacent shingles, according to one embodiment.

FIG. 4 is an isometric view of the roof facing bottom side of a shingle showing the adhesive and the protective backing material being removed, according to one embodiment.

FIG. 5 is an isometric view of a roof showing the components of the electrical interconnection system, according to one embodiment.

FIG. 6 is a section view of the electrical interconnection system showing the roof underlayment connecting to the membrane forming a seal, according to one embodiment.

FIG. 7 is a large-scale section view of the interface between the membrane and solar shingle, according to one embodiment.

FIG. 8A is an isometric view of a short solar shingle showing the electrical contacts that interface with adjacent solar shingles, according to one embodiment.

FIG. 8B is an isometric view of a short module stacked on top of and adhesively connected to a large module, according to one embodiment.

FIG. 9 is an isometric view showing a series of solar shingles of various sizes connected to the electrical interconnection system, according to one embodiment.

FIG. 10 is an isometric view of a series of shingles on a portion of a roof deck, according to one embodiment.

FIG. 11 is an isometric view of a series of shingles on a portion of a roof deck, according to another embodiment.

FIG. 12 is an isometric view of a series of shingles on a portion of a roof deck, according to one embodiment.

### DETAILED DESCRIPTION OF THE DRAWINGS

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

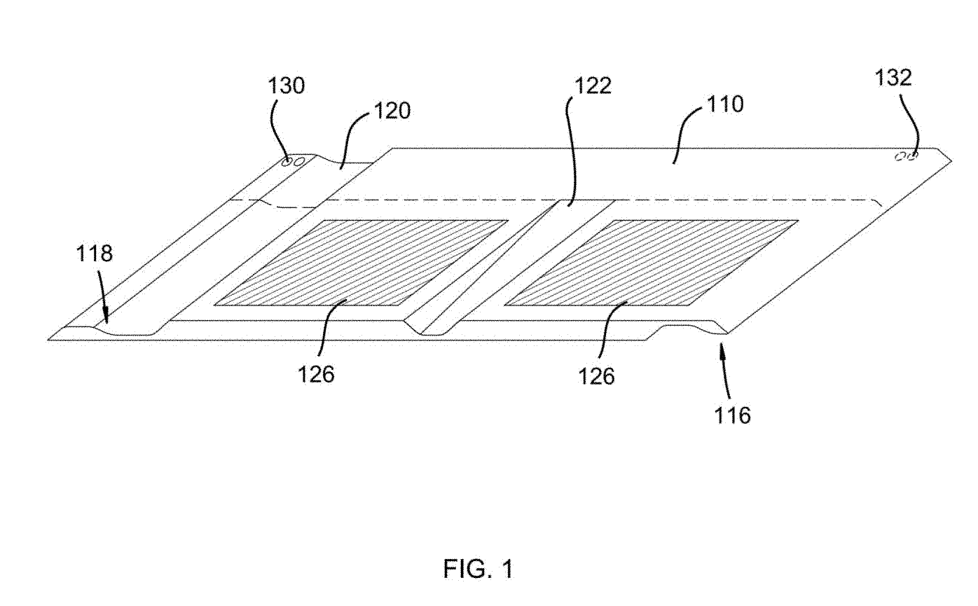

FIG. 1 is an isometric view of a solar shingle, according to one example embodiment. Electrical contacts 130 connect solar shingle 110 to an adjacent solar shingle. Contacts 132 connect the solar shingle to an adjacent solar shingle or to an electrical circuit embedded in a membrane. Channel 120 provides a connection trough for the adhesive attachment of adjacent solar shingle, and provides a channel for water to be drawn down and away from the electrical contact area. Protruding edge 116 interlocks with receiving edge of an adjacent solar shingle. In a similar fashion, receiving edge 118 interlocks with a protruding edge of an adjacent solar shingle. Photovoltaic module surface area 126 is also shown. Channel 122 is shown running from a location at least 1″ from a top edge of the solar shingle and extending to a bottom edge of the solar shingle. The base of the channel 122 ramps down to the bottom edge of the solar shingle to allow water to be drawn down and away from the face of the shingle. This channel is superior to the standard configuration of 3 tab shingles because there is a base material providing a continuous structure between the tabs.

In another embodiment, Channel 120 provides a connection trough for the adhesive attachment of adjacent shingle, and provides a channel for water to be drawn down and away from the attachment area. Protruding edge 116 interlocks with receiving edge of an adjacent shingle. In a similar fashion, receiving edge 118 interlocks with a protruding edge of an adjacent shingle. Shingle surface area 126 is also shown. Channel 122 is shown running from a location at least 1″ from a top edge of the shingle and extending to a bottom edge of the shingle. The base of the channel 122 ramps down to the bottom edge of the solar shingle to allow water to be drawn down and away from the face of the shingle. This channel is superior to the standard configuration of 3 tab shingles because there is a base material providing a continuous structure between the tabs.

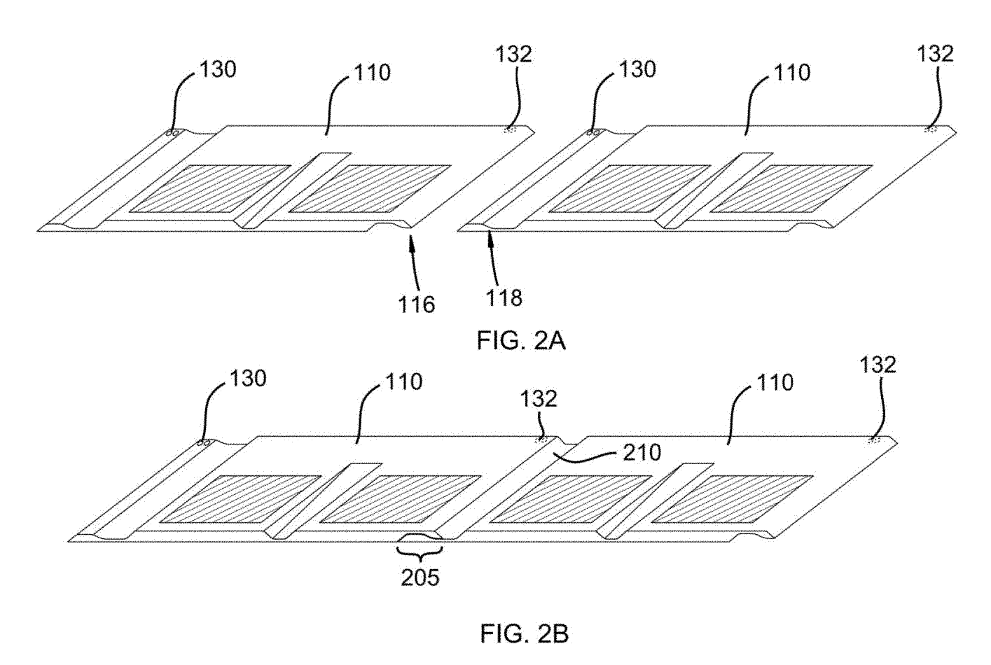

FIG. 2A is an isometric view of a two adjacent shingles not connected together. Two adjacent shingles 110 are shown before connection. Protruding edge 116 is shaped to conform to adjacent receiving edge 118. In another embodiment, shingles 110 are solar shingles with contacts 130 and 132 for connection to adjacent solar shingles.

FIG. 2B is an isometric view of a two adjacent shingles 110 connected together. Overlap area 205 is shown where the two adjacent shingles 110 are adhesively connected together, creating channel 210. In another embodiment, shingles 110 are solar shingles with contacts 130 and 132 for connection to adjacent solar shingles.

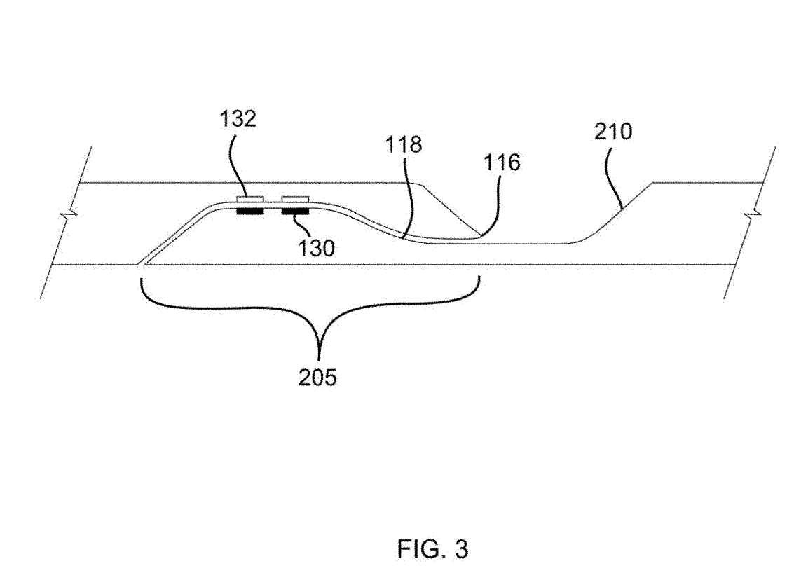

FIG. 3 is a cross section view showing the connection of two adjacent shingles. Overlap area 205 is shown where the two adjacent shingles are adhesively connected together. Protruding edge 116 is shaped to conform to adjacent receiving edge 118. Contacts 132 electrically connect to contacts 130 providing a pathway for current to flow from one solar shingle to another. Channel 210 allows for water to be drawn down and away from the contact area. The convex shape of the channel interface with contacts 130 embedded therein is at a higher elevation than the base of channel 210, preventing water from penetrating up into the contact area. Additionally, the adhesive between the two solar shingle surfaces within overlap area 205 further protects from water intrusion.

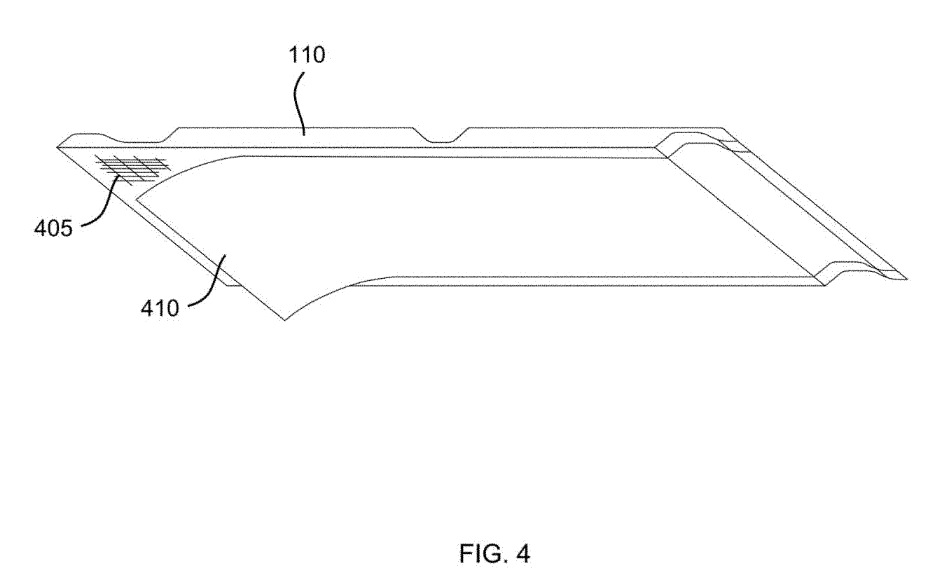

FIG. 4 is an isometric view of the roof facing bottom side of a shingle 110 showing the adhesive 405, and the protective backing material 410 being removed.

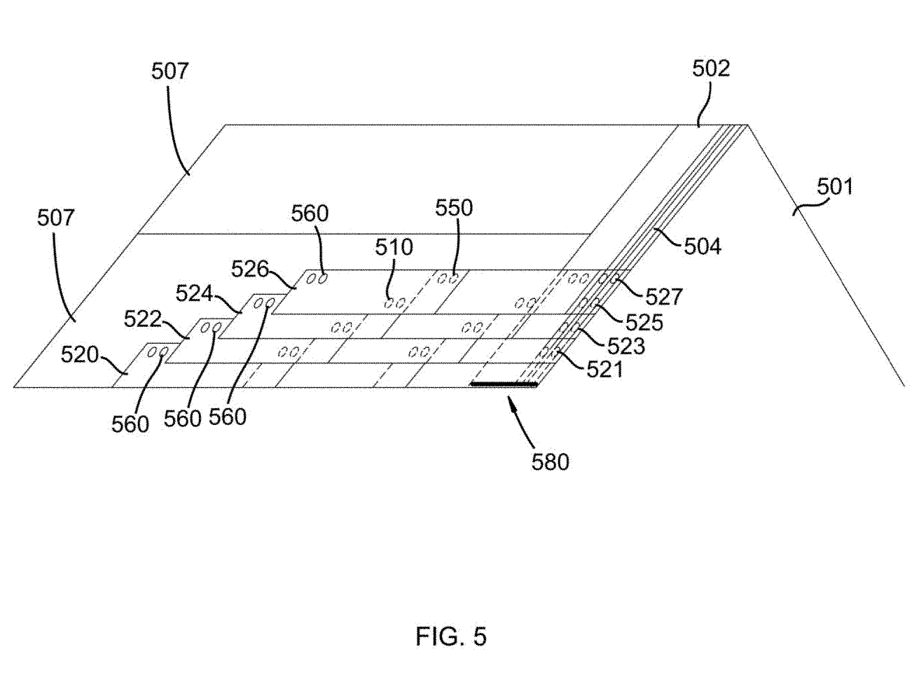

FIG. 5 is an isometric view of a roof showing the components of the electrical interconnection system. The membrane 502 is shown on one side of a roof 501 and extends from the top of the roof down to the bottom of the roof. The membrane 502 is cut to fit the length of the roof and is sealed 580 with an electrically insulating and waterproof sealant. Rows of solar shingles 520, 522, 524 and 526 are shown installed on top of roofing underlayment 507. Electrical contacts 560 are shown that connect solar shingles to adjacent solar shingles. Electrical contacts 510 and 550 are on a bottom side of the solar shingles and are electrically and environmentally protected, both by the adhesive and also by the solar shingles overlapping the contact area. Contacts 521, 523, 525 and 527 are shown connecting shingle rows 520, 522, 524 and 526 to the membrane interface area 504.

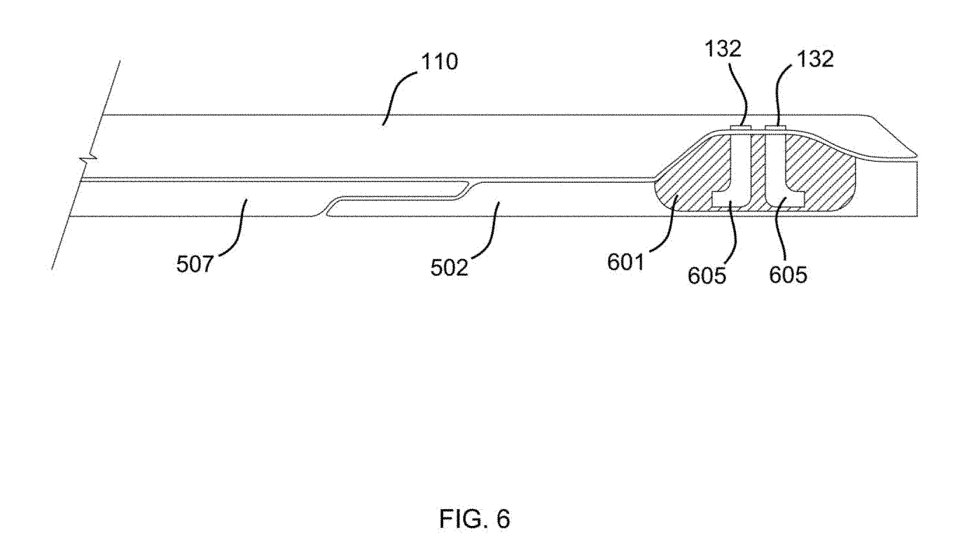

FIG. 6 is a section view of the electrical interconnection system showing the roof underlayment 507 connecting to the membrane 502 forming a seal. Insulation 601 is shown protecting electrical conductors 605. The electrical conductors 605 connect to contacts 132 in the solar shingle 110.

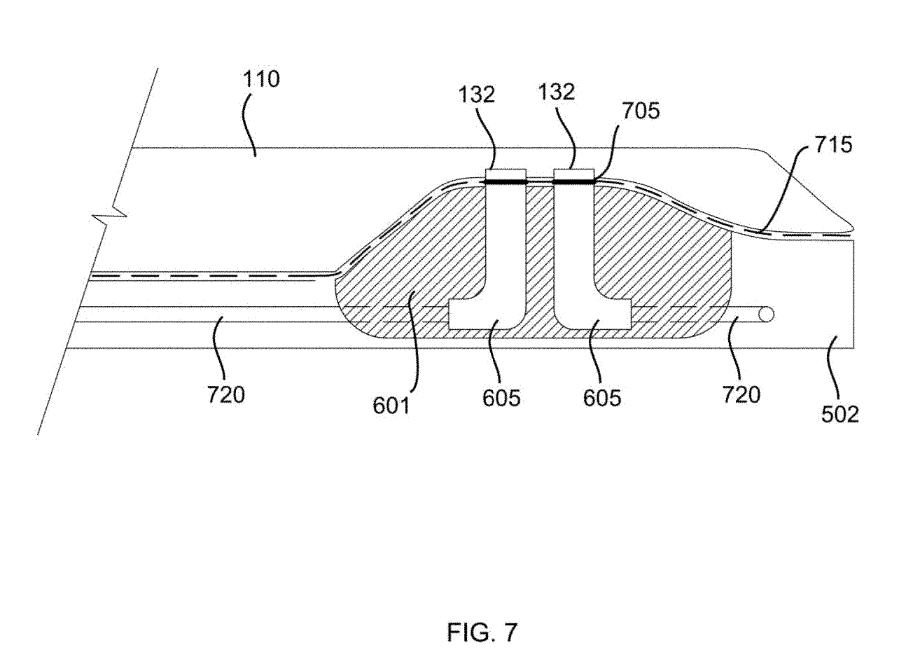

FIG. 7 is a large-scale section view of the interface between the membrane 502 and electrical module 110. Electrical wiring 720 is shown penetrating through the insulation 601, and connecting to the electrical conductors 605. Contacts 132 inside the solar shingle 110 are electrically connected by an electrically conductive material 705 to a conductive surface of the electrical conductors 605 as shown. Electrically insulating adhesive 715 connects the solar shingle 110 to the membrane 502 and holds this connection in place providing an electrical pathway from the module to the electrical interconnection system.

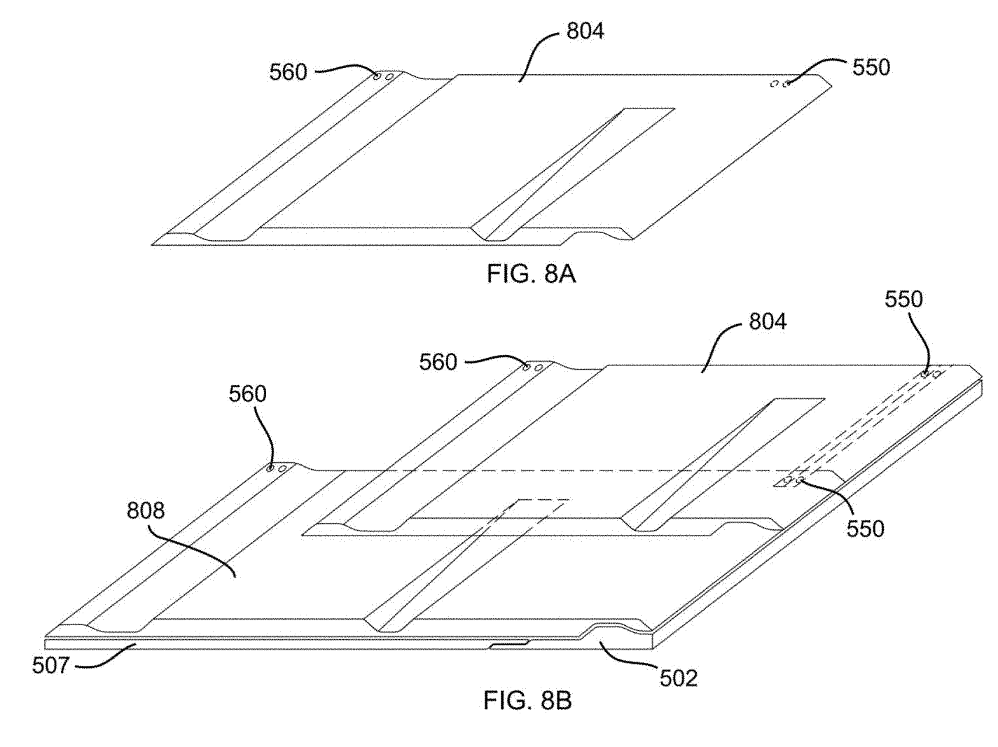

FIG. 8A is an isometric view of a short solar shingle 804 showing the electrical contacts 560 that interface with adjacent solar shingles. The contacts 550 connect to either the membrane or to an adjacent solar shingle.

FIG. 8B is an isometric view of a short module 804 stacked on top of and adhesively connected to a large module 808. Contacts 560 are shown which provide an electrical interface for adjacent solar shingles. The solar shingles are adhesively attached to the roof underlayment 507 and membrane 502. Solar shingle electrical contacts 550 are connected to the membrane conductors as shown.

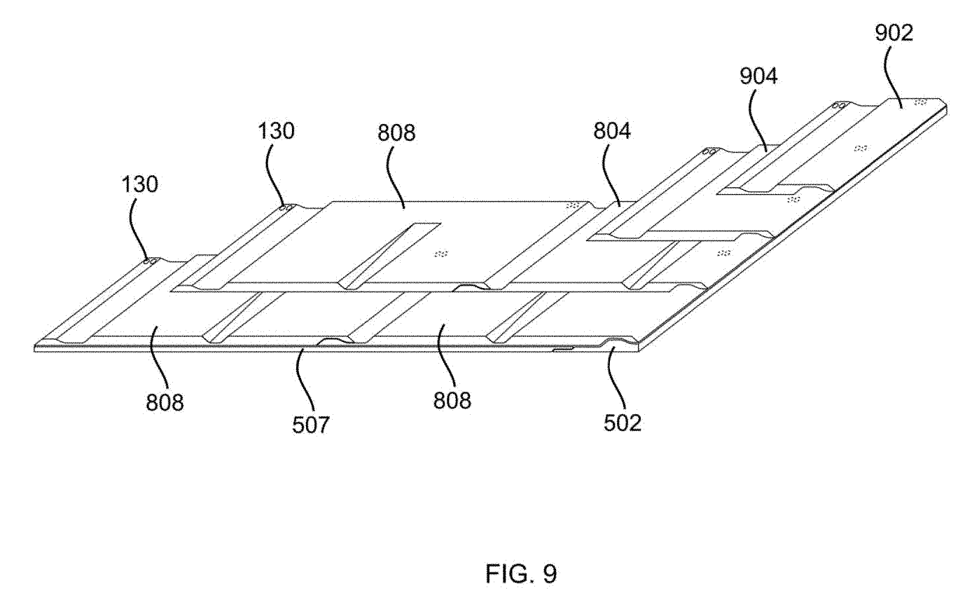

FIG. 9 is an isometric view showing a series of solar shingles of various sizes connected to the electrical interconnection system. Small solar shingle 902 is stacked on top of medium solar shingle 904 which is on top of a larger solar shingle 804, which is then on top of a full-sized solar shingle 808. Contacts 130 are shown which provide an electrical interface for adjacent solar shingles. The solar shingles are adhesively attached to the membrane 502 and roof underlayment 507 as shown.

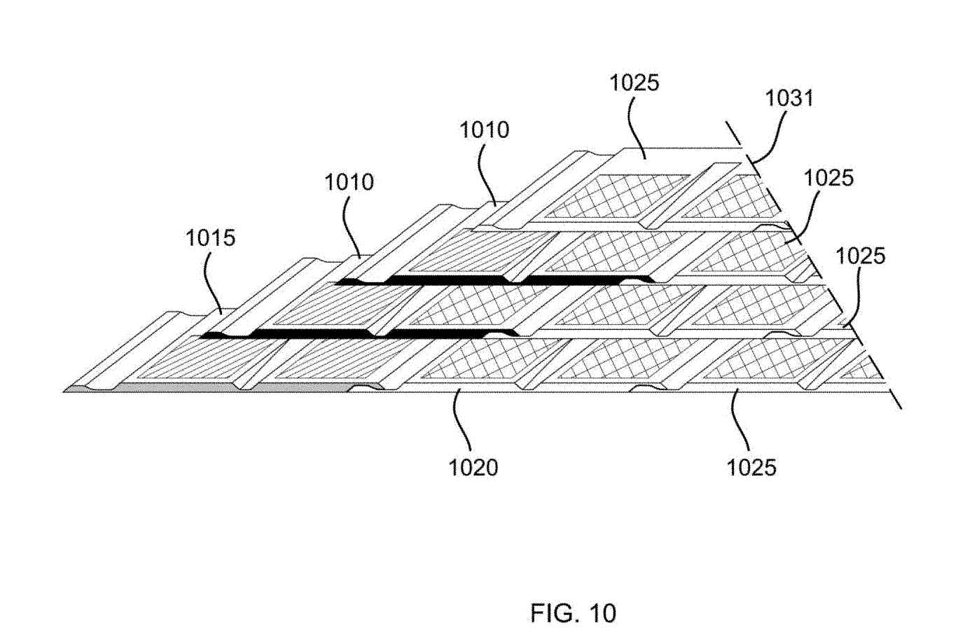

FIG. 10 is an isometric view of a series of shingles on a portion of a roof deck. Full size solar shingle 1015 is connected to congruent shingle 1020 on the base row which is then connected to partial congruent shingle 1025. Partial congruent shingle 1025 has been cut along line 1031 to accommodate roof valley or other roof obstruction. Combination shingles 1010 are also shown with a portion of the shingle being solar photovoltaic. Other congruent shingles 1025 are shown that have been cut to allow for the roof obstruction as shown.

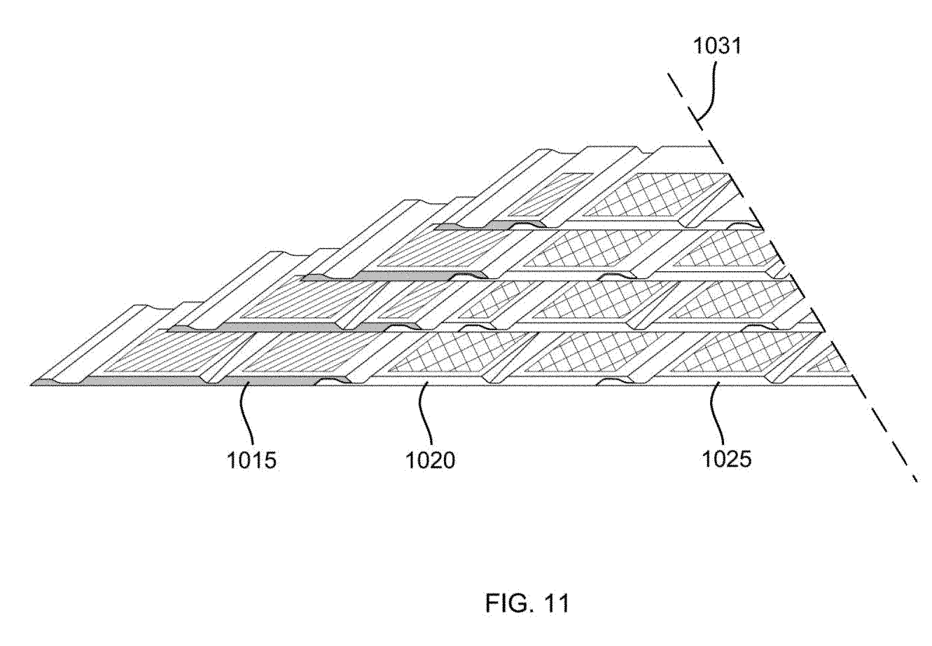

FIG. 11 is an isometric view of a series of shingles on a portion of a roof deck. Full-size solar shingle 1015 is connected to full-size congruent shingle 1020 on the base row which is then connected to partial congruent shingle 1025. Partial congruent shingles 1025 are cut along line 1031 to allow for the roof obstruction as shown.

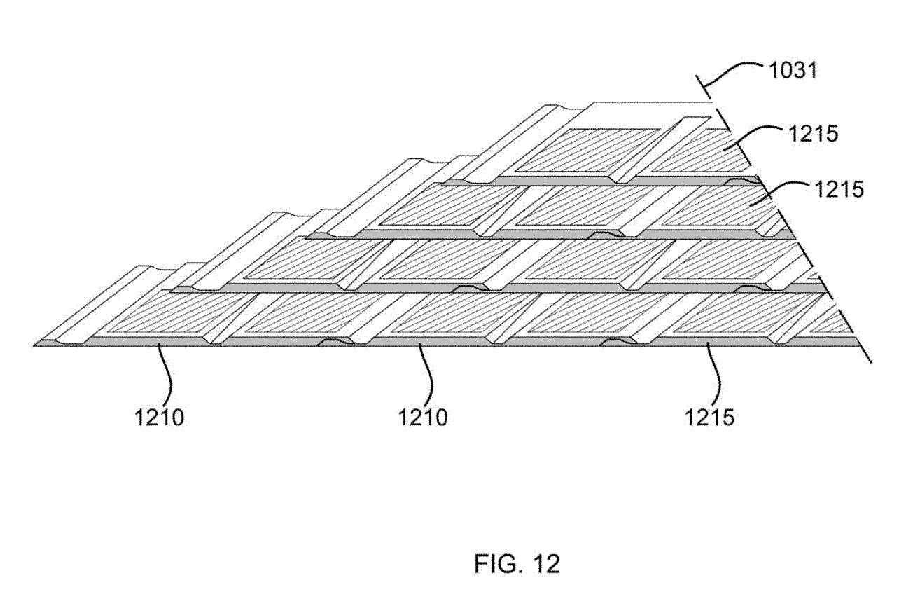

FIG. 12 is an isometric view of a series of shingles on a portion of a roof deck. Full size solar shingles 1210 are comprised of an amorphous silicon composition. Partial solar shingles 1215 along the cut line 1031 are still functional (producing a lower electrical current) after they have been cut to accommodate roof obstructions.

1. (canceled)

2. The solar roofing system of claim 2, wherein the truncated channel begins at a location at least 1″ from the top side of the solar roofing shingle.

3. The roofing system of claim 2, wherein the channel along the left short side comprises a convex cross-section and the channel along the right short side comprises a concave cross-section.

4. The solar roofing system of claim 2, wherein each of the plurality of solar roofing shingles comprises an adhesive covered by a protective backing material and wherein the protective backing material is removed at a time of installation, exposing the adhesive.

5. The solar roofing system of claim 2, wherein each of the plurality of solar roofing shingles comprises a photovoltaic module embedded within the solar shingle.

6. (canceled)

7. (canceled)

8. The solar roofing system of claim 5, wherein each solar roofing shingle comprises photovoltaic material.

9. The solar roofing system of claim 5, wherein each solar roofing shingle further comprises a plurality of contacts adjacent the respective channels along the right and left short sides wherein the contacts electrically connect the solar shingle to an adjacent solar shingle.

10. The solar roofing system of claim 9, wherein each solar roofing shingle further comprises electrical wiring connecting the photovoltaic module to the contacts.

11. The solar roofing system of claim 5, wherein the photovoltaic module further comprises control circuitry which controls an electrical current flowing between one or more solar roofing shingles.

12. The solar roofing system of claim 5, wherein one or more solar roofing shingles of the plurality of shingles are connected to an electrical interconnection system comprising one or more at least partially insulated electrical conductors;
a waterproof membrane;
wherein the partially insulated electrical conductors are embedded within the membrane;
a conductive surface of the partially insulated electrical conductors being exposed on an exterior surface of the membrane;
electrical wires connected to each of the one or more linear lengths of partially insulated electrical conductors; and
wherein the conductive surface on the exterior surface of the membrane is only exposed in areas that align to the contacts of the one or more solar roofing shingles electrically connected thereto.

13. The solar roofing system of claim 12, wherein the conductive surface is adhesively attached and electrically connected to one or more solar roofing shingles.

14. (canceled)

15. The solar roofing system of claim 12, wherein the conductive surface is coated with an electrically conductive material that enables electrical conduction from the electrical contact to the conductive surface.

16. The solar roofing system of claim 15, wherein an electrically insulating adhesive coats a surface area between a first side of the membrane and the one or more solar roofing shingles, creating an air tight and moisture tight seal encapsulating an area surrounding the electrically conductive material.

17. The solar roofing system of claim 12, wherein the electrical conductors and the conductive surface is comprised of one or more of electrically conductive materials including alloys of copper, aluminum, nickel, stainless steel, silver, graphite, tungsten, and carbide.

18. The solar roofing system of claim 15, wherein the electrical connection materials comprise electrically conductive adhesive.

19. The solar roofing system of claim 18, wherein the electrically conductive adhesive comprises carbon, graphite, tungsten, graphene, gallium, rubidium, phosphorus, carbon nanotubes, carbide, or a combination thereof

20. The solar roofing system of claim 16, wherein the electrically insulating adhesive allows for expansion and contraction.

21. A solar roofing system comprising:
a plurality of solar roofing shingles, each shingle comprising a top surface and a bottom surface and opposed right and left short sides intersecting the top and bottom sides normal to the short sides,
the left short side comprising a protruding edge comprising a channel adjacent to the protruding edge running the length of the left short side and open to the top surface;
the right short side comprising a receiving edge comprising a channel adjacent to the receiving edge running the length of the right short side and open to the bottom surface,
wherein the plurality of roofing shingles interconnect by overlapping along the respective channels with adjacent solar roofing shingles similarly configured;
the solar roofing shingles further comprising one or more truncated channels open to the top surface disposed intermediate and parallel to the respective short sides, the truncated channels being closed adjacent to the top side and open to the bottom side of each respective solar roofing shingle and the truncated channel comprising a base ramp leading downward to the bottom side.
